(19) United States
(12) Patent Application Publication
(10) Pub. No.: US 2008/0148597 A1
(43) Pub. Date: Jun. 26, 2008

(54) DRYER WITH CLOGGING DETECTING FUNCTION

(75) Inventors: Yang-hwan KIM, Sasang-gu (KR); Kyung-hun KIM, Changwon-shi (KR); Ja-in KOO, Changwon-shi (KR); Ju-hyun KIM, Jinhae-shi (KR); Sun-cheol BAE, Masan-shi (KR); Ju-young MIN, Changwon-shi (KR); Jin-seok HU, Masan-shi (KR)

Correspondence Address: KED & ASSOCIATES, LLP, P.O. Box 221200, Chantilly, VA, 20153-1200, US

(73) Assignee: LG Electronics Inc.

(21) Appl. No.: 11/963,343

(22) Filed: Dec. 21, 2007

(30) Foreign Application Priority Data
Dec. 26, 2006 (KR) 10-2006-0133895
Dec. 26, 2006 (KR) 10-2006-0133897

(51) Int. Cl. F26B 21/06; F26B 19/00; F26B 13/10; G08B 21/00

(52) U.S. Cl. 34/549; 34/572; 34/524; 340/607

(57) ABSTRACT

A clogging detecting apparatus for a dryer is provided that can check a clogging state of an air passage according to an off time of a drying operation. The clogging detecting apparatus may include a heater for heating the air of the air passage, a temperature control unit for turning on/off a power supply from a power unit to the heater according to a temperature of the air passage or a temperature of the heater, and a judgment unit for judging the clogging state of the air passage according to an on/off time of the temperature control unit. The clogging detecting apparatus may precisely judge the clogging state of the air passage according to a quantity of laundry dried in the dryer regardless of external factors such as a variation of an external common power.

The present application claims priority from Korean Patent Application No. 10-2006-0133895, filed Dec. 26, 2006 and Korean Patent Application No. 10-2006-0133897 filed Dec. 26, 2006, the subject matters of which are incorporated herein by reference.

### BACKGROUND

1. Field

Embodiments of the present invention may relate to a dryer. More particularly, embodiments of the present invention may relate to a dryer with a clogging detecting function that can check a clogging state of an air passage according to an off time of a drying operation.

2. Background

A washing machine with a drying function may include a main body formed in a predetermined shape, a drum installed in the main body, a tub for surrounding the drum and for collecting the wash water, and a driving motor for rotating the drum. The washing machine may also include a detergent container for supplying a detergent, a water supply tube connected to the detergent container for supplying the wash water only or for supplying the wash water mixed with detergent of the detergent container, a drain tube for externally discharging the wash water used in washing, and a pump and a drain hose connected to the end of the drain tube for forcibly discharging the wash water.

In the washing machine with the drying function, after the laundry and the wash water are put into the drum, the drum may be rotated so that the laundry can be dropped in a gravity direction and washed by friction with the wash water. The drum type washing machines may not only wash the laundry but may also dry the laundry by hot air.

Washing machines with a drying function may be classified as a condensation type washing machine and an exhaust type washing machine. In the condensation type washing machine, hot air generated by a heater may be sent to a drum by a ventilation fan for drying the laundry in the drum. After drying the laundry, the air in the drum may become high temperature high humidity air that flows to an exhaust hole communicating with a tub. A nozzle for spraying cold water may be installed at one side of the exhaust hole for removing moisture from the high temperature high humidity air, and again supplying the dry air to the ventilation fan.

In the exhaust type washing machine, hot air generated by a heater and a ventilation fan may pass through the laundry in a drum, and may be externally exhausted from the washing machine through an exhaust hole formed at one side of the washing machine. The exhaust hole may be linked to a corrugated hose connected to a tub. In case a baby or a pet is kept shut up in the washing machine, the exhaust hole may serve as a vent hole.

When the exhaust type washing machine with the drying function dries the laundry, lint (fine fluff) may be generated from the laundry. The lint may be circulated with the hot air in the drum of the washing machine, and may be externally discharged from the washing machine through the exhaust hole.

A structure for periodically collecting the lint generated from the laundry after washing may be provided to prevent the lint from accumulating on the exhaust hole of the washing machine. That is, a lint filter may be mounted in the exhaust hole to prevent the lint from clogging up the exhaust hole over long time use of the washing machine.

FIG. 1 is a schematic configuration view of a dryer according to an example arrangement. Other arrangements may also be provided. As shown in FIG. 1, a dryer 100 may include a heater 110 for receiving external common power and generating heat, and a first thermostat TS1 and a second thermostat TS2 for supplying the external common power to the heater 110.

The first thermostat TS1 is a mechanical switch for cutting off power supply when the ambient temperature of the heater 110 is over a predetermined temperature. Once the first thermostat TS1 is turned off, the first thermostat TS1 may not automatically return to the on state. The second thermostat TS2 is a mechanical switch for cutting off power supply when the ambient temperature of the heater 110 is greater than the predetermined temperature, and resuming power supply when the ambient temperature is below the predetermined temperature. The first thermostat TS1 may be mounted to provide for an abnormal operation of the second thermostat TS2.

In the dryer 100, when a number of turn-off operations of the first and second thermostats TS1 and TS2 is greater than a predetermined number, the air flow passing through an exhaust pipe may be deemed to be abnormal. In addition, when the size of the external common power is not constant, the first and second thermostats TS1 and TS2 may be turned off, namely, easily affected by factors that are not associated with a clogging state of the exhaust pipe.

When a small quantity of laundry is put into the dryer 100, the first and second thermostats TS1 and TS2 may be turned off once or twice till completion of a drying operation. In this case, it is meaningless to set the predetermined number of times. Accordingly, air flow of the exhaust pipe can not be judged.

When the first and second thermostats TS1 and TS2 break down, the dryer 100 may not have any structure for recognizing or notifying the use of the breakdown of the first and second thermostats TS1 and TS2. As a result, when the first and second thermostats TS1 and TS2 break down, the heater 110 may overheat and cause a fire.

### BRIEF DESCRIPTION OF THE DRAWINGS

Arrangements and embodiments may be described in detail with reference to the following drawings in which like reference numerals refer to like elements and wherein:

FIG. 1 is a schematic configuration view a dryer according to an example arrangement;

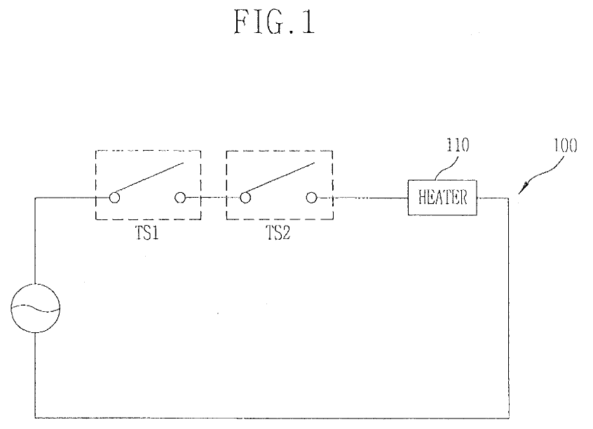

FIG. 2 is a cross-sectional view illustrating a dryer in accordance with an example embodiment of the present invention;

FIG. 3 is an exploded perspective view illustrating a dryer in accordance with an example embodiment of the present invention;

FIG. 4 is a partial cutaway view illustrating a dryer in accordance with an example embodiment of the present invention;

FIG. 5 is a configuration view illustrating a clogging detecting apparatus for a dryer in accordance with an example embodiment of the present invention;

FIG. 6 is a circuit view illustrating a detection circuit of FIG. 5;

FIGS. 7 and 8 are graphs showing output waveforms of the detection circuit according to an example embodiment of the present invention;

FIG. 9 is a graph showing on/off recognized by a microcomputer according to an example embodiment of the present invention;

FIG. 10 is a flowchart showing driving of a clogging detecting apparatus for a dryer in accordance with an example embodiment of the present invention;

FIG. 11 is a flowchart showing driving of a clogging detecting apparatus for the dryer in accordance with an example embodiment of the present invention;

FIG. 12 is a configuration view illustrating a safety device for a dryer in accordance with an example embodiment of the present invention;

FIG. 13 is a graph showing on/off recognized by a microcomputer according to an example embodiment of the present invention; and

FIG. 14 is a flowchart showing driving of a safety device for a dryer in accordance with an example embodiment of the present invention.

### DETAILED DESCRIPTION

A clogging detecting apparatus for a dryer in accordance with example embodiments of the present invention will now be described in detail with reference to the accompanying drawings.

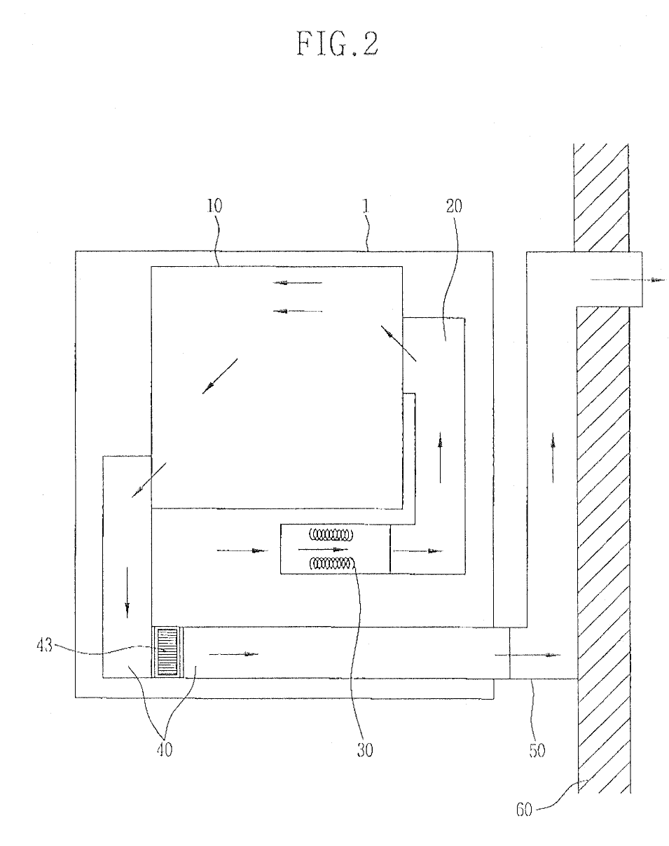

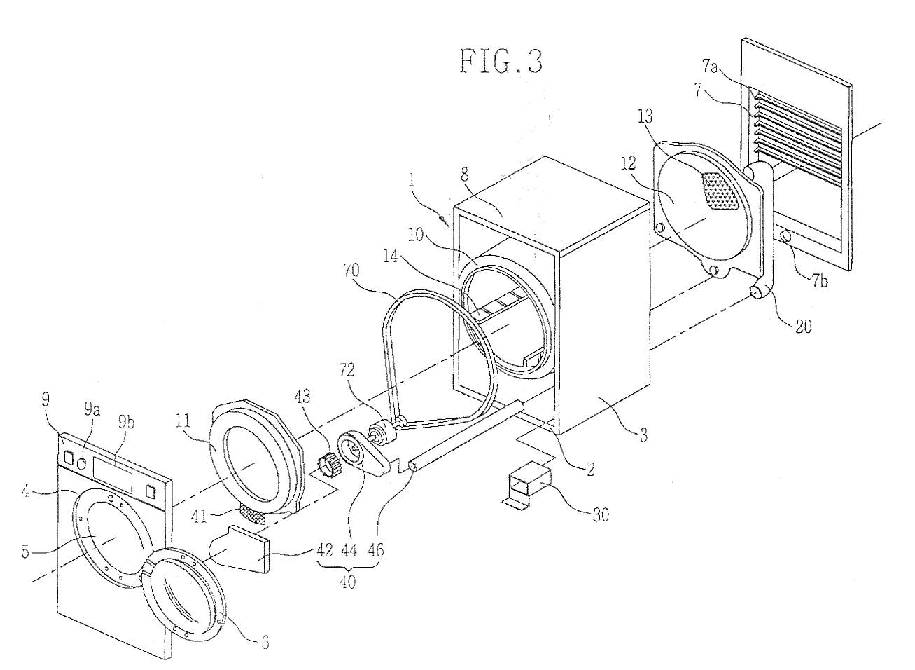

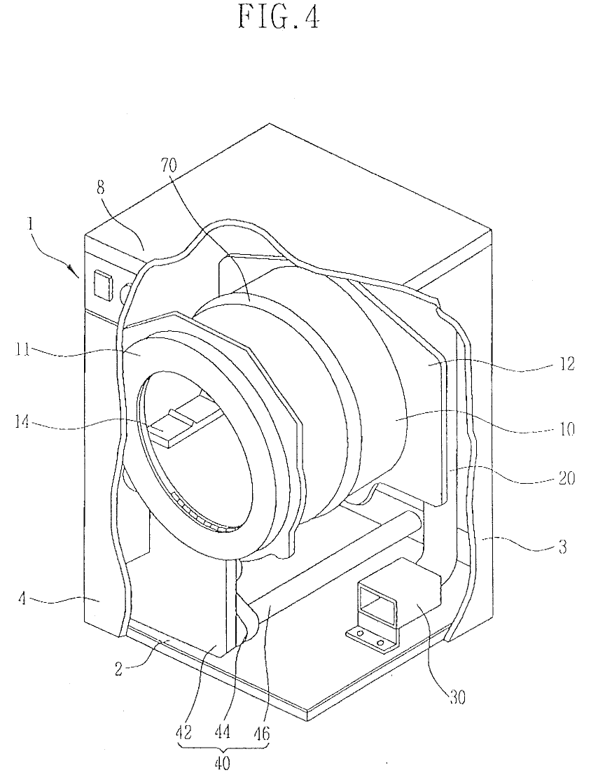

FIG. 2 is a cross-sectional view illustrating a dryer in accordance with an example embodiment of the present invention. FIG. 3 is an exploded perspective view illustrating a dryer in accordance with an example embodiment of the present invention. FIG. 4 is a partial cutaway view illustrating a dryer in accordance with an example embodiment of the present invention. Other embodiments and configurations are also within the scope of the present invention. An exhaust type dryer exemplified below is not intended to be limiting.

As shown in FIG. 2, an exhaust type dryer includes a drum 10 disposed in a cabinet 1 for containing the laundry, a suction passage 20 for supplying air into the drum 10, a heater 30 installed on the suction passage 20, and an exhaust passage 40 for externally exhausting the air passing through the drum 10 from the cabinet 1. For the exhaust type dryer, an exhaust duct 50 may be coupled to the exhaust passage 40 for externally exhausting air through an inner wall 60 of a building.

A ventilation fan 43 may be installed at one side of the suction passage 20 or the exhaust passage 40. The ventilation fan 43 may be installed at one side of the exhaust passage 40.

As shown in FIGS. 3 and 4, the cabinet 1 may include a base pan 2, a cabinet main body 3 installed at an upper portion of the base pan 2, a cabinet cover 4 installed on a front surface of the cabinet main body 3, a back panel 7 installed on a rear surface of the cabinet main body 3, a top cover 8 installed on a top surface of the cabinet main body 3, and a control panel 9 installed at a top end of the cabinet cover 4.

FIG. 3 also shows a laundry inlet 5 for putting laundry into the drum 10 being formed on the cabinet cover 4, and a door 6 for opening and closing the laundry inlet 5 being rotatably connected to the cabinet cover 4. The control panel 9 may be installed at the top end of the cabinet cover 4. The control panel 9 may include an input unit 9a for acquiring an input from the user, and a display unit 9b for displaying a state of the dryer 1 (e.g., a drying processing state, a drying processing degree, a remaining drying time, selection of a drying mode, a clogging state of an air passage, etc.). A front supporter 11 for rotatably supporting the front end of the drum 10 may be mounted at the rear portion of the cabinet cover 4.

A rear supporter 12 for rotatably supporting the rear end of the drum 10 may be mounted at the front portion of the back panel 7. A communication hole 13 for making the suction passage 20 and the inlet portion of the drum 10 communicate with each other may be formed on the rear supporter 12 so that the air passing through the suction passage 20 can be supplied to the inlet portion of the drum 10.

As shown in FIGS. 3 and 4, the drum 10, which is a cylindrical container for containing the laundry, may be opened in forward and backward directions so that air can pass through the drum 10 in the forward and backward directions. The rear opening portion may form the inlet portion of the drum 10, and the front opening portion may form the outlet portion of the drum 10. A lift 14 for lifting and dropping the laundry during rotation of the drum 10 may protrude from an inner circumference of the drum 10.

The suction passage 20 may be formed by a suction duct having its bottom end connected to communicate with the rear end of the heater 30 and its top end connected to communicate with the communication hole 13 of the rear supporter 12.

The heater 30 installed on the top surface of the base pan 2 may include a heater casing communicating with the suction passage 20 (i.e., the suction duct 20) and a heat generation coil arranged in the heater casing. When power is supplied to the heat generation coil, inside space of the heater casing and the heater casing itself may be heated so that the air passing through the heater casing can be converted into the high temperature low humidity air.

The exhaust passage 40 may be formed by a lint duct 42 communicating with an outlet portion of the drum 10 to exhaust the air from the drum 10, a lint filter 41 for filtering off impurities such as lint from the exhausted air being mounted on the lint duct 42, a fan housing 44 communicating with the lint duct 42 and housing a ventilation fan 43, and an exhaust pipe 46 having one end connected to communicate with the fan housing 44 and another end externally elongated from the cabinet 1. The exhaust duct 50 for guiding the air externally exhausted from the cabinet 1 to the outdoor space may be connected to the exhaust pipe 46. The exhaust duct 50 may be formed outside the cabinet 1 for guiding the air to the outdoor space. The exhaust duct 50 can be installed to pass through the inner wall 60 of the building.

The air passage may include the suction passage 20, an inside space of the drum 10, the exhaust passage 40 and the exhaust duct 50. Clogging of the air passage may mostly occur in the lint filter 41 of the exhaust passage 40 and the exhaust duct 50. The air flow may be relatively less interrupted by clogging of the lint filter 41 of the exhaust passage 40 than clogging of the exhaust duct 50.

An operation of the exhaust type dryer in accordance with an example embodiment of the present invention will now be described.

When the user puts laundry into the drum 10, closes the door 6 and operates the exhaust type dryer by controlling the control panel 9, the exhaust type dryer may turn on the heater 30 and drive a motor 72.

When the heater 30 is turned on, the heater 30 heats the inside of the dryer, and when the motor 72 is driven, a belt 70 and the ventilation fan 43 are rotated. When the belt 70 is rotated, the drum 10 is rotated. The laundry in the drum 10 may be repeatedly lifted and dropped by the lift 14.

When the ventilation fan 43 is rotated, outdoor air of the cabinet 1 may be sucked into an air suction hole 7a of the back cover 7 by an air blast force of the ventilation fan 43, and the air may be supplied to a gap between the cabinet 1 and the drum 10. The air in the gap between the cabinet 1 and the drum 10 may be introduced to the heater 30, heated into the high temperature low humidity air, and sucked into the drum 10 through the suction passage 20 and the communication hole 13 of the rear supporter 12.

The high temperature low humidity air sucked into the drum 10 may flow in a forward direction of the drum 10, become the high humidity air by contact with the laundry, and be exhausted to through exhaust passage 40.

The air exhausted to the exhaust passage 40 may pass through the exhaust pipe 46, and be externally exhausted through the exhaust duct 50.

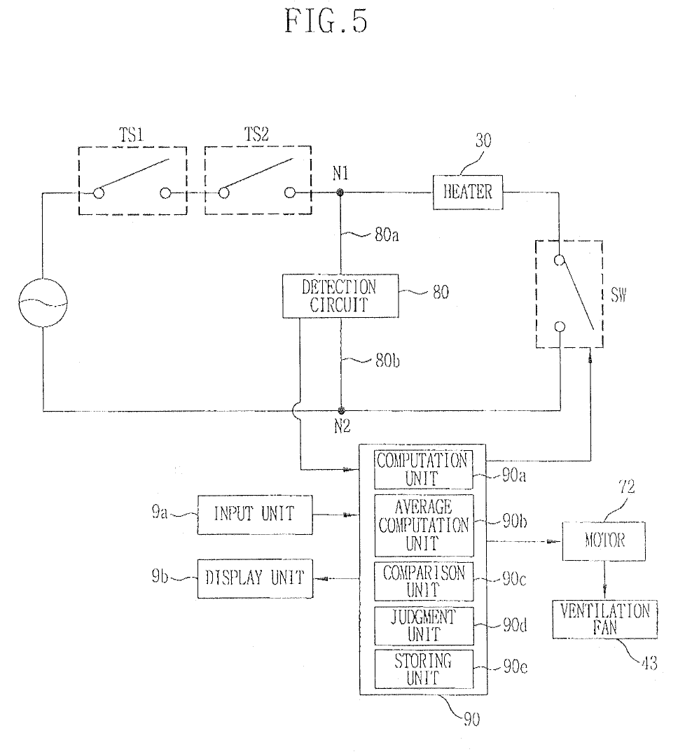

FIG. 5 is a configuration view illustrating a clogging detecting apparatus for a dryer in accordance with an example embodiment of the present invention. Other embodiments and configurations are also within the scope of the present invention. As shown in FIG. 5, the clogging detecting apparatus may include first and second thermostats TS1 and TS2 for supplying external common power to the heater 30. The first and second thermostats TS1 and TS2 may be turned on/off according to a temperature of the heater 30 or a temperature of the air heated by the heater 30. The clogging detecting apparatus may also include a switch SW turned on/off by a control command of a microcomputer 90 for applying the common power to the heater 30, the input unit 9a, the display unit 9b, the heater 30, the ventilation fan 43, and the motor 72. The clogging detecting apparatus may also include a detection circuit 80 for judging power supply to the heater 30 according to on/off of the first and second thermostats TS1 and TS2, and a microcomputer 90 for judging the clogging state of the air passage according to a detection signal from the detection circuit 80. A power supply unit for supplying DC power from the common power supply source to the microcomputer 90, the input unit 9a and the display unit 9b is not shown in FIG. 5. However, the power supply unit may be provided.

The first and second thermostats TS1 and TS2, which are temperature control units, may be mounted in a side or proximity of the heater 30 to react to temperature of the heater 30 or temperature of the air heated by the heater 30. If the temperature does not reach a predetermined overheat temperature, the first and second thermostats TS1 and TS2 may be continuously on. If the temperature exceeds the overheat temperature, the first and second thermostats TS1 and TS2 may be turned off so as not to apply the common power to the heater 30. In disadvantageous arrangements, once the first thermostat TS1 is turned off, the first thermostat TS1 may not return to the on state. For example, the first and second thermostats TS1 and TS2 may be mounted on the suction passage 20 connected to the heater 30.

The switch SW, which is a relay, may maintain the on state during the drying operation by on control of the microcomputer 90, and maintain the off state by off control of the microcomputer 90.

The input unit 9a may receive a control command for drying and a clogging detection command for air passage from the user, and apply the commands to the microcomputer 90.

The display unit 9b may display not only the user input for the drying operation, the drying processing degree and remaining drying time but also the clogging state of the air passage (e.g., clogging of the air passage, clogging of the exhaust duct 50, clogging of the lint filter 41, etc.)

The detection circuit 80 may be connected to nodes N1 and N2 for deciding whether current flows in a serial circuit including the heater 30 (i.e., whether power is supplied to the heater 30). For this, the detection circuit 80 may be connected to the nodes N1 and N2 through connection lines 80a and 80b, respectively. Since the detection circuit 80 is installed on the control panel 9 on which the microcomputer 90 is being mounted, the connection lines 80a and 80b may be provided along the inside space between the drum 10 and the cabinet main body 3 or the inner surface of the cabinet main body 3.

The detection circuit 80 may judge whether power is supplied to the heater 30 according to on/off operations of the first and second thermostats TS1 and TS2 by the temperature of the heater 30 or the air. Power supply to the heater 30 may also be controlled by the switch SW operated by control of the microcomputer 90. When the switch SW is turned on, the microcomputer 90 checks the power supply state according to the detection signal from the detection circuit 80. When the switch SW is turned off, the microcomputer 90 may not consider the signal from the detection circuit 80.

The detection circuit 80 may apply different signals (detection signals) to the microcomputer 90 according to the power supply state so that the microcomputer 90 can check the power supply state of the heater 30. Differently from FIG. 5, the input terminals of the detection circuit 80 may also be connected between the first thermostat TS1 and the common power supply source and between the heater 30 and the switch SW, respectively. In the serial circuit that includes the common power supply source, the first and second thermostats TS1 and TS2, the heater 30 and the switch SW, a potential difference of both ends of the heater 30 may be most clearly identified according to supply of the common power. Therefore, the detection circuit 80 may be connected to always detect a potential difference of the portion including the heater 30.

As described above, the microcomputer 90 may perform the drying operation by directly controlling the heater 30, the switch SW and the motor 72 according to a command of the user from the input unit 9a, and by controlling the ventilation fan 43 by the motor 72.

The microcomputer 90 and the detection circuit 80 may be mounted on the rear surface of the control panel 9.

In addition, the microcomputer 90 may judge information on power supply and cutoff by the first and second thermostats TS1 and TS2 according to the detection signal from the detection circuit 80.

The microcomputer 90 may include a computation unit 90a, an average computation unit 90b, a comparison unit 90c, judgment unit 90d and a storing unit 90e. The computation unit 90a may compute an off time of the first and second thermostats TS1 and TS2 according to the detection signal. The average computation unit 90b may compute an average off time of the first and second thermostats TS1 and TS2 according to the detection signal. The comparison unit 90c may compare the off time or the average off time with a preset reference off time, or the comparison unit 90c may compare the previous clogging state of the air passage with the current clogging state of the air passage. The judgment unit 90d may judge the clogging state of the air passage when the off time or the average off time exceeds the reference off time as a comparison result of the comparison unit 90c. The storing unit 90e may store the judged clogging state of the air passage and the preset reference off time.

The off time of the first and second thermostats TS1 and TS2 (hereinafter also referred to as a temperature control unit) computed by the computation unit 90a may be less affected by a size variation of the external common power. If the quantity of the laundry is small, then the off time may decrease. On the other hand, if the quantity of the laundry is large, then the off time may increase.

The average computation unit 90b may compute the average off time in each off state so as not to be affected by a size variation of the external common power. The average off time may be more precise when the quantity of the laundry is middle or large, and the off time computed by the computation unit 90a may be more precise when the quantity of the laundry is small.

For example, when the whole drying time is about two hours, the reference off time stored in the storing unit 90e may be set as 130 seconds. When the power cutoff time by the temperature control unit exceeds the reference off time, the judgment unit 90d judges that the clogging degree of the air passage is serious. In addition, the storing unit 90e may store a plurality of reference off times. For instance, the reference off times may be set as 130 seconds and 60 seconds. If the off time or the average off time exceeds 130 seconds, then the judgment unit 90d may judge that the clogging degree of the air passage is high, (i.e., the exhaust duct 50 is clogged up). If the off time or the average off time ranges from 60 to 130 seconds, the judgment unit 90d may judge that the clogging degree of the air passage is middle (i.e., the lint filter 41 is clogged up).

The microcomputer 90 may display the information on the clogging state or degree and the clogged part of the air passage on the display unit 9b. The display unit 9b may operate as a visible and audible display, and thus may include an audible display device (for example, a speaker).

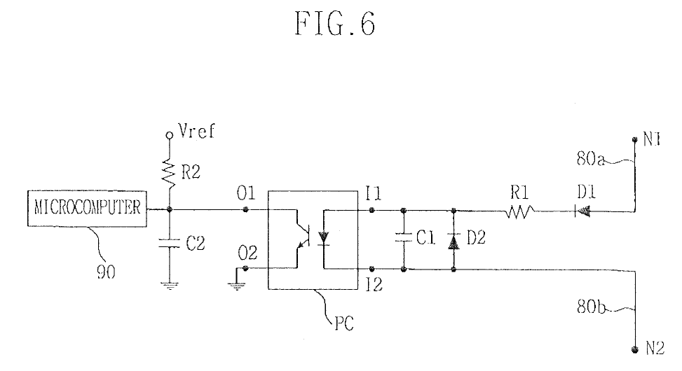

FIG. 6 is a circuit view illustrating the detection circuit of FIG. 5. As shown in FIG. 6, the detection circuit 80 may include a diode D1 for applying a positive (+) voltage among input voltages from the node N1, a resistor R1 for reducing the input voltage from the node N1, a diode D2 and a capacitor C1 for preventing noise contained in the input voltage applied to input terminals 11 and 12 of a photocoupler PC. The photocoupler PC may be turned on/off according to the input voltage. The detection circuit 80 may also include a resistor R2 and a capacitor C2 connected to an output terminal O1 of the photocoupler PC for supplying different voltage waveforms below a reference voltage Vref, which is a DC voltage to the microcomputer 90 according to on/off of the photocoupler PC. The reference voltage Vref may be used as a driving voltage of the microcomputer 90. For ease of discussion, explanations of a power supply unit for generating the reference voltage Vref are omitted. Generation of the reference voltage Vref may be easily recognized by one skilled in the art.

When the common power is AC 240 V, then the potential difference between the nodes N1 and N2 may be about 240 V. If this voltage is applied to the photocoupler PC, the voltage may damage the photocoupler PC. The resistor R1 may be provided to reduce the input voltage into a few tens V.

If the potential difference exists between the nodes N1 and N2 (i.e., if the first and second thermostats TS1 and TS2 are turned on to supply power to the heater 30), a voltage corresponding to the potential difference is applied to the input terminals of the photocoupler PC. Because the voltage is an AC voltage, an inside photodiode may emit light according to a period of the voltage, and a transistor, which is a light receiving unit, may be turned on/off for applying a square wave to the microcomputer 90. If the potential difference does not exist between the nodes N1 and N2 (i.e., if the first and second thermostats TS1 and TS2 are turned off to not supply power to the heater 30), the input terminals of the detection circuit 80 may have a same potential. Accordingly, the inside photodiode may not emit light, and the transistor, which is the light receiving unit, may be turned off for continuously applying DC voltage waveforms approximate to the reference voltage Vref to the microcomputer 90.

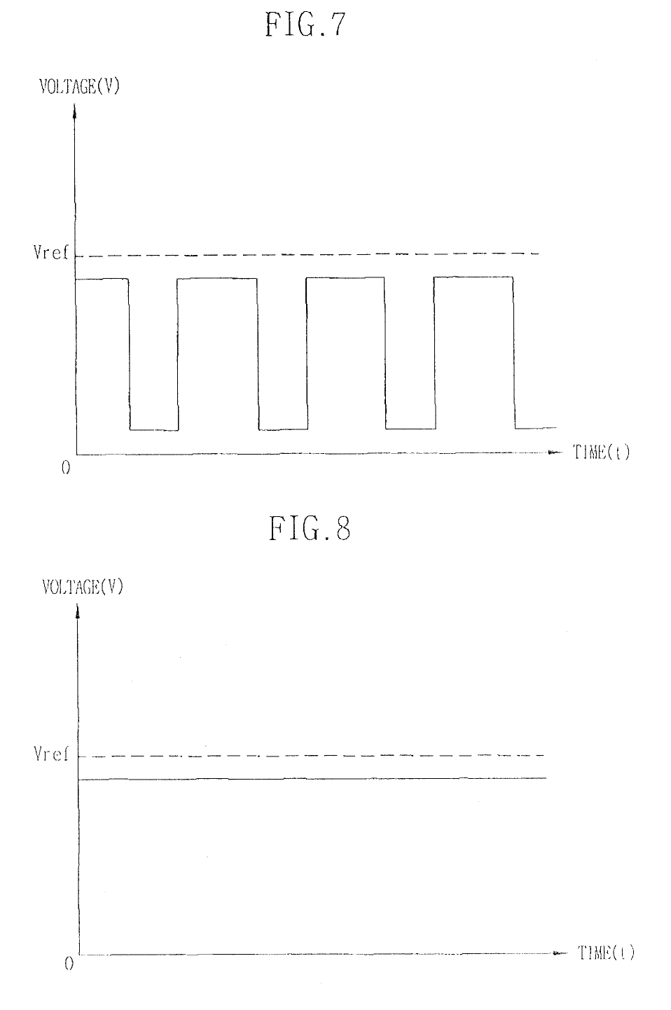

FIGS. 7 and 8 are graphs showing output waveforms of a detection circuit according to example embodiments of the present invention. Other embodiments, configurations and graphs are also within the scope of the present invention. As shown in FIG. 7, when the first and second thermostats TS1 and TS2 are turned on, the common power, which is the AC voltage, may be applied to the heater 30. A voltage difference equivalent in size to the common power may be generated between the nodes N1 and N2. The photocoupler PC may be turned on due to the voltage difference. Since the common power is the AC voltage, the photocoupler PC may be repeatedly turned on/off according to the period of the common power, thereby applying a square wave smaller than the reference voltage Vref to the microcomputer 90.

As shown in FIG. 8, when the first or second thermostat TS1 or TS2 is turned off, power may not be supplied to the heater 30. The nodes N1 and N2 may therefore have the same potential. As a result, the photocoupler PC may be always turned off, thereby applying the DC voltage (for example, high signal) approximate to the reference voltage Vref to the microcomputer 90.

Therefore, the microcomputer 90 may compute the power cutoff time of the heater 30 by the off states of the first and second thermostats TS1 and TS2 according to the waveform of the applied DC voltage.

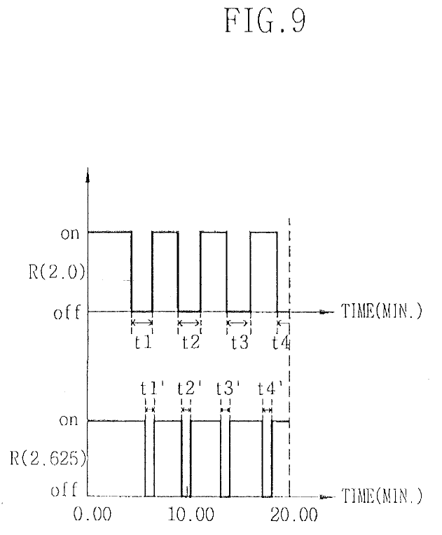

FIG. 9 is a graph showing on/off recognized by a microcomputer according to an example embodiment of the present invention. Other embodiments and configurations are also within the scope of the present invention. As shown in FIG. 9, the microcomputer 90 recognizes information on power supply and cutoff by the first and second thermostats TS1 and TS2 according to the signals of FIGS. 7 and 8. In FIG. 9, R represents a diameter of the exhaust duct 50, and the used unit is inch. More specifically, when the diameter of the exhaust duct 50 is R(2.0) and R(2.625), the microcomputer 90 recognizes on/off of the power supply to the heater 30 according to the signal from the detection circuit 80 of FIGS. 7 and 8. If the diameter is large, the state (clogging degree) of the air passage is weak, and if the diameter is small, the state (clogging degree) of the air passage is serious.

In the example of FIG. 9, when the drying operation is performed for 20 minutes, the number of times of the off operations of the temperature control unit is four, regardless of the diameter. However, in each off state, the off times t1, t2, t3 and t4 of R (2.0) may be much larger than the off times t1′, t2′, t3′ and t4′ of R(2.625). In addition, the average off time (t1+t2+t3+t4)/4 of R(2.0) may be much larger than the average off time (t1′+t2′+t3′+t4′)/4 of R(2.625). It may therefore be possible to judge the clogging degree corresponding to the diameter of the exhaust duct 50 according to the off time or the average off time of the temperature control unit.

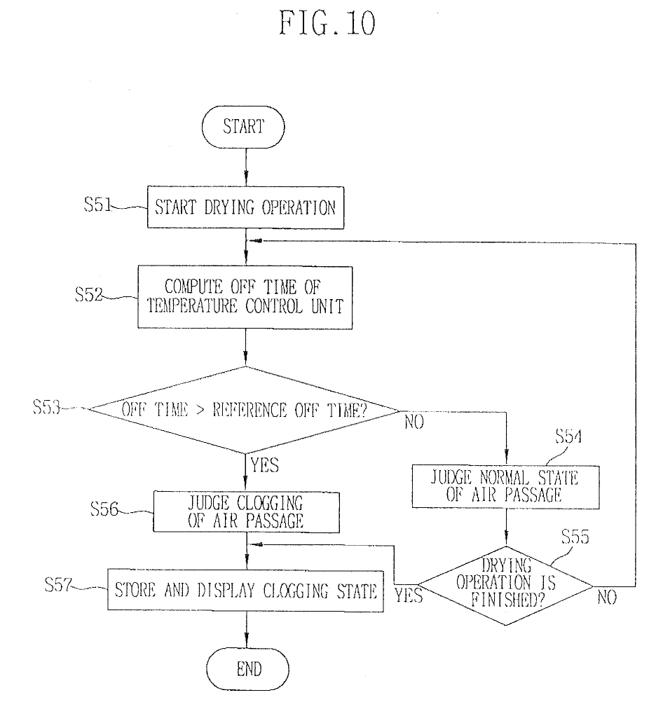

FIG. 10 is a flowchart showing driving of a clogging detecting apparatus for a dryer in accordance with an example embodiment of the present invention. Other operations, orders of operations and embodiments are also within the scope of the present invention.

More specifically, in operation S51, the microcomputer 90 turns on the switch SW to supply power to the heater 30, and drives the motor 72 and the ventilation fan 43, thereby starting the drying operation.

In operation S52, the microcomputer 90 computes the off time of the temperature control unit by the computation unit 90a according to the detection signal from the detection circuit 80.

In operation S53, the comparison unit 90c of the microcomputer 90 compares the computed off time with the reference off time prestored in the storing unit 90e. If the computed off time is greater than the reference off time, the microcomputer 90 may proceed to operation S56. If the computed off time is not greater than the reference off time, the microcomputer 90 may proceed to operation S54.

In operation S54, the judgment unit 90d judges that the current state of the air passage is normal.

In operation S55, the microcomputer 90 judges whether the current drying operation has been finished. If the drying operation has been finished, the microcomputer 90 proceeds to operation S57. If the drying operation has not been finished, the microcomputer 90 proceeds to operation S52 and continuously checks the state of the air passage.

In operation S56, the judgment unit 90d judges that the current state of the air passage is the clogging state.

In operation S57, if the routine comes from operation S56, the microcomputer 90 may store and display the clogging state of the air passage. Meanwhile, if the routine comes from operation S55, the microcomputer 90 may store and display the normal state of the air passage.

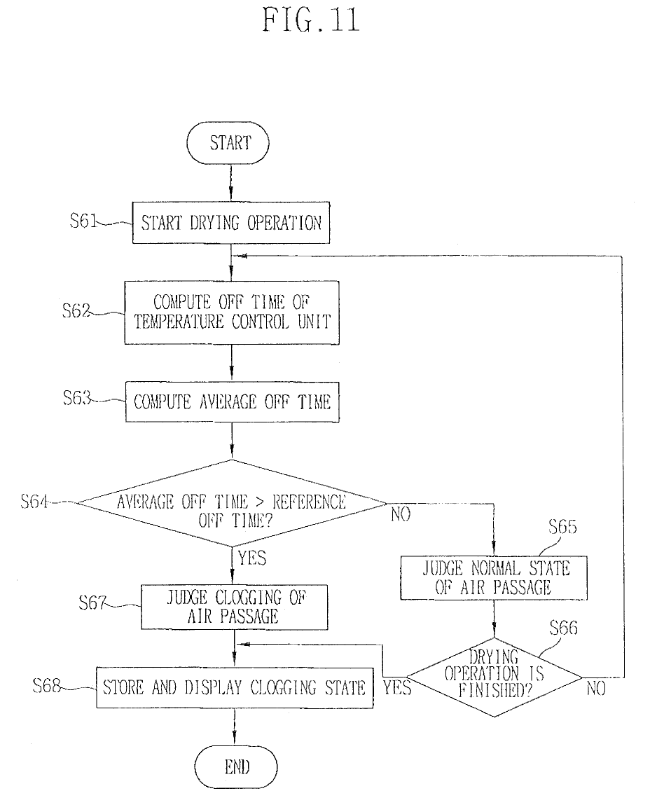

FIG. 11 is a flowchart showing driving of a clogging detecting apparatus for a dryer in accordance with an example embodiment of the present invention. Other operations, orders of operations and embodiments are also within the scope of the present invention.

Operations S61 and S62 may correspond to operations S51 and S52 of FIG. 10.

In operation S63, the average computation unit 90b may compute the average off time by a number of times of the off operations of the temperature control unit.

In operation S64, the comparison unit 90c of the microcomputer 90 may compare the computed average off time with the reference off time prestored in the storing unit 90e. If the computed average off time is greater than the reference off time, the microcomputer 90 may proceed to operation S67. If the computed average off time is not greater than the reference off time, then the microcomputer 90 may proceed to operation S65.

In operation S65, the judgment unit 90d may judge that the current state of the air passage is normal.

In operation S66, the microcomputer 90 may judge whether the current drying operation has been finished. If the drying operation has been finished, the microcomputer 90 may proceed to operation S68. If the drying operation has not been finished, the microcomputer 90 may proceed to operation S62 and continuously check the state of the air passage.

In operation S67, the judgment unit 90d may judge that the current state of the air passage is the clogging state.

In operation S68, if the routine comes from operation S67, the microcomputer 90 may store and display the clogging state of the air passage. Meanwhile, if the routine comes from operation S66, the microcomputer 90 may store and display the normal state of the air passage.

In the above flowcharts, when the user inputs the clogging detection command for the air passage through the input unit 9a, a clogging detecting method for the dryer may perform the operations after the operations S52 and S62.

In addition, a clogging detecting method for the dryer may judge clogging of the exhaust duct 50, clogging of the lint filter 41 or the normal state by using a plurality of reference off times.

Further, the clogging detecting method for the dryer may reset the reference off time according to a quantity of the laundry by using an algorithm for sensing the quantity of the laundry in the drum 10, and perform the operations S53 and S64 by using the reset reference off time.

The comparison unit 90c of the microcomputer 90 may compare the prestored clogging state (i.e., the off time and the average off time) of the air passage with the currently judged clogging state (i.e., the off time and the average off time) of the air passage, check the clogging progressive (increase or decrease) degree of the air passage according to the increase or decrease of the off time and the average off time, and display the clogging progressive degree on the display unit 9b.

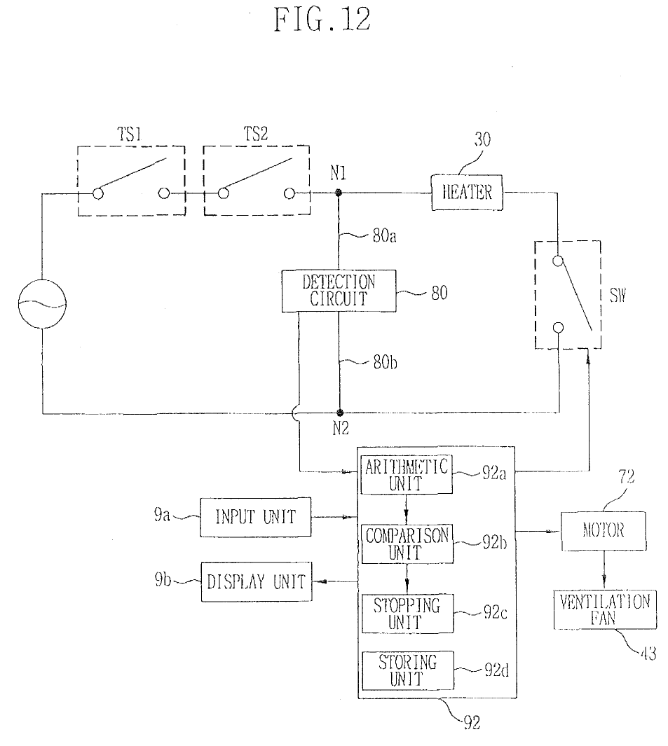

FIG. 12 is a configuration view illustrating a safety device for a dryer in accordance with an example embodiment of the present invention. Other embodiments and configurations are also within the scope of the present invention. The elements of the safety device for the dryer of FIG. 12, which have the same reference numerals as those of the clogging detecting apparatus for the dryer of FIG. 5, may perform similar or same functions/operations.

The microcomputer 92 may perform the drying operation by controlling the heater 30, the switch SW and the motor 72 according to command of the user from the input unit 9a, and may control the ventilation fan 43 by the motor 72.

The microcomputer 92 and the detection circuit 80 may be mounted on the rear surface of the control panel 9.

The microcomputer 92 may judge information on power supply and cutoff by the first and second thermostats TS1 and TS2 according to the detection signal from the detection circuit 80.

The microcomputer 90 may include an arithmetic unit 92a, a comparison unit 92b, a stopping unit 92c and a storing unit 92d. The arithmetic unit 92a may accumulate the off times of the first and second thermostats TS1 and TS2 according to the detection signal. The comparison unit 92b may compare the accumulated off time with a preset reference accumulated time. The stopping unit 90c may judge a normal operation impossibility of at least one of the first and second thermostats TS1 and TS2 when the accumulated off time is greater than the reference accumulated time as the comparison result of the comparison unit 92b, cutting off power supply to the heater 30 by controlling the switch SW, and stopping driving of the motor 72 and the ventilation fan 43. More specifically, in the case that the first and second thermostats TS1 and TS2 are normally operated, the reference accumulated time for the off times of the first and second thermostats TS1 and TS2 have been prestored in the storing unit 92d by the microcomputer 92. Therefore, the accumulated off time may be equal to or smaller than the reference accumulated time. When the first and second thermostats TS1 and TS2 are abnormally operated, the accumulated off time may be greater than the reference accumulated time. Accordingly, power supply to the heater 30 may be cut off, and the drying operation may not be normally performed. The microcomputer 92 may judge such a state. Since the first thermostat TS1 may be permanently off, power may not be supplied to the heater 30 without replacing the first thermostat TS1.

The microcomputer 92 may display an operation impossible state resulting from abnormal states of the first and second thermostats TS1 and TS2 on the display unit 9b. The display unit 9b may operate as a visible and audible display, and thus may include an audible display device (e.g., a speaker).

The microcomputer 92 may store the operation impossible state of the first and second thermostats TS1 and TS2 in the storing unit 92d. An EEPROM may be used as the storing unit 92d, for example.

Therefore, when the dryer is newly supplied with an external common power, the user may not recognize the operation impossible state of the first and second thermostats TS1 and TS2. Thus, the microcomputer 92 may display the operation impossible state on the display unit 9b, and prevent the drying operation until the operation impossible state of the first and second thermostats TS1 and TS2 is overcome.

The display unit 9b may display not only the user input for the drying operation, the processing degree of the drying operation and remaining time of the drying operation, but also normal operation possibility of the first or second thermostats TS1 and TS2 (e.g., a text or error code indicating normal operation impossibility of the temperature control unit).

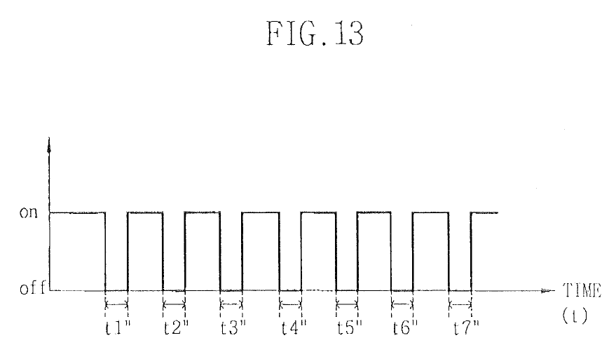

FIG. 13 is a graph showing on/off recognized by a microcomputer according to an example embodiment of the present invention. Other operations, embodiments and graphs are also within the scope of the present invention. The microcomputer 92 may recognize information on power supply and cutoff by the first and second thermostats TS1 and TS2 according to the signal of FIGS. 7 and 8. The microcomputer 92 may accumulatively compute off times of the first and second thermostats TS1 and TS2. For example, the microcomputer 92 may compute an accumulated off time by accumulatively adding off times t1″ to t7″.

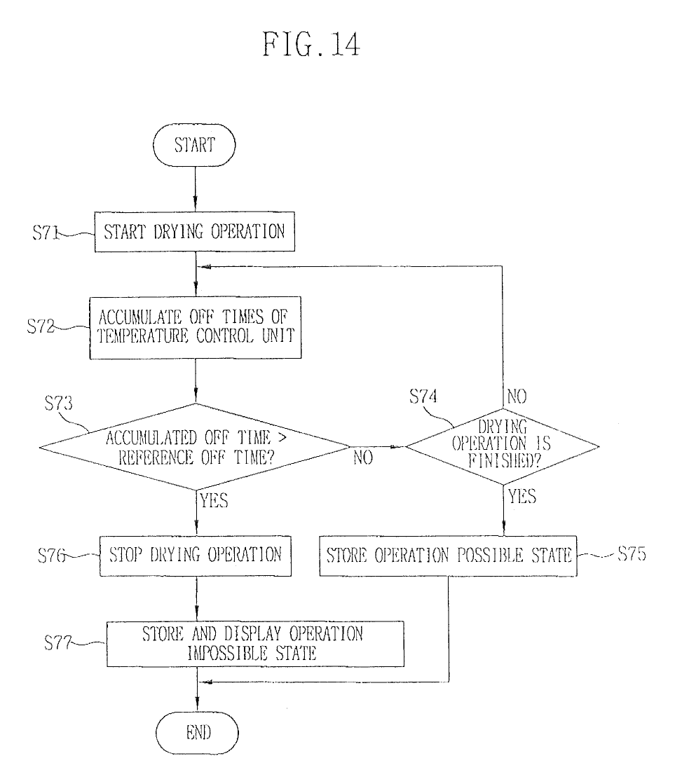

FIG. 14 is a flowchart showing driving of a safety device for a dryer in accordance with an example embodiment of the present invention. Other operations, orders of operations and embodiments are also within the scope of the present invention.

As stated above, the first and second thermostats TS1 and TS2 may be referred to as a temperature control unit. In the driving example of FIG. 14, the dryer may detect the operation state of the temperature control unit during the drying operation.

More specifically, in operation S71, the microcomputer 92 may apply the on command to the switch SW to operate the heater 30, and drive the motor 72 and the ventilation fan 43, thereby starting the drying operation.

In operation S72, the arithmetic unit 92a of the microcomputer 92 may check the on/off state of the temperature control unit according to the detection signal from the detection circuit 80, and accumulatively compute the off times. As the drying operation proceeds, as described above, the temperature control unit may control the temperature by repeating the on/off state.

In operation S73, the comparison unit 92b of the microcomputer 92 may compare the accumulated off time with the reference off time prestored in the storing unit 92d. If the accumulated off time is greater than the reference off time, the microcomputer 92 may proceed to operation S76. If the accumulated off time is not greater than the reference off time, then the microcomputer 92 may proceed to operation S74. For example, the reference off time can be set as 400 seconds. The reference off time may be variably set according to the quantity of the laundry put into the dryer.

In operation S74, the microcomputer 92 judges whether the current drying operation has been finished. If the drying operation has been finished, the microcomputer 92 may proceed to operation S75. If the drying operation has not been finished, the microcomputer 92 may proceed to operation S72 and continuously perform the drying operation.

In operation S75, since the temperature control unit is in the normal state (i.e., the operation possible state), the microcomputer 92 may store the operation possible state of the temperature control unit in the storing unit 92d.

In operation S76, the stopping unit 92c of the microcomputer 92 may preferentially stop heat generation of the heater 30 by applying the off command to the switch SW according to the result of the comparison unit 92b, and then stop driving of the motor 72, thereby stopping the drying operation. If the drying operation is carried out in the operation impossible state of the temperature control unit, an unexpected problem such as a fire or damage of clothes may occur in the dryer.

In operation S77, the microcomputer 92 may store the operation impossible state of the temperature control unit in the storing unit 92d, and display the text or error code (e.g., a thermostat error (TSE)) indicating the operation impossible state of the temperature control unit on the display unit 9b.

Since the microcomputer 92 has stored the operation impossible state of the temperature control unit in the storing unit 92d by the above operation S77, even if the user turns off power of the dryer 1 and then resumes power supply, the microcomputer 92 can display the operation impossible state of the temperature control unit stored in the storing unit 92d.

Embodiments of the present invention may provide a dryer with a clogging detecting function that can judge a clogging state of an air passage without being affected by an external factor.

Embodiments of the present invention may provide a dryer with a clogging detecting function that can judge a clogging state of an air passage according to a quantity of laundry.

Embodiments of the present invention may provide a dryer with a clogging detecting function that can precisely check a state of an air passage by using a power supply/cutoff detection device.

Embodiments of the present invention may provide a dryer with a safety function that can judge and notify a breakdown of a thermostat to a user.

Embodiments of the present invention may provide a dryer with a safety function that can prevent overheating of a heater by stopping a drying operation during a breakdown of a thermostat.

Embodiments of the present invention may provide a dryer with a safety function that can continuously display a breakdown of a thermostat so that a user can manage or repair the thermostat.

Embodiments of the present invention may provide a dryer with a clogging detecting function. The dryer may include a heater for heating air of an air passage, a temperature control unit for turning on/off power supply from a power unit to the heater according to a temperature of the air passage or a temperature of the heater, and a judgment unit for judging a clogging state of the air passage according to an on/off time of the temperature control unit. The clogging detecting apparatus for the dryer may precisely judge the clogging state of the air passage according to a quantity of laundry dried in the dryer regardless of external factors such as a variation of an external common power.

The dryer may include a display unit for displaying the clogging state of the air passage. Accordingly, the user may be provided with the precisely judged clogging state of the air passage.

The dryer may include a comparison unit for comparing the clogging state of the air passage with a prestored clogging state. The dryer may additionally judge a progressive degree of the clogging state of the air passage.

The judgment unit may judge a normal operation possibility of the temperature control unit according to the on/off time of the temperature control unit. When the temperature control unit can not be operated due to a breakdown during the drying operation of the dryer, the judgment unit may judge an operation impossibility of the temperature control unit so that the user may solve the problem.

The dryer may include an operation stopping unit interworking with the judgment unit for stopping a drying operation of the dryer. If the temperature control unit is in the operation impossible state, the operation stopping unit may stop the drying operation for the safety of the user and the dryer.

Embodiment of the present invention may provide a dryer with a clogging detecting function that includes a heater for heating the air of an air passage, a temperature control unit for turning on/off power supply from a power unit to the heater according to a temperature of the air passage or a temperature of the heater, a detection unit for detecting an on/off state of the temperature control unit, and a state judgment unit for judging a clogging state of the air passage by computing an off time of the temperature control unit according to a detection signal from the detection unit. The dryer may rapidly and precisely compute the off time of the temperature control unit according to the power supply/cutoff state, and may precisely judge the clogging state of the air passage according to the computed off time.

The state judgment unit may include a comparison unit for comparing the computed off time with a reference off time, and a judgment unit for judging clogging of the air passage when the computed off time is greater than the reference off time. The clogging state of the air passage can be precisely judged through the comparison using the reference off time.

The state judgment unit may includes an average computation unit for computing an average off time of the computed off times, a comparison unit for comparing the average off time with the reference off time, and a judgment unit for judging clogging of the air passage when the average off time is greater than the reference off time. The clogging state of the air passage may be precisely judged through comparison using the average off time.

Input terminals of the detection unit may be connected between the temperature control unit and the heater and to the power unit, respectively. An output terminal of the detection unit may be connected to the state judgment unit to precisely detect power supply/cutoff by the temperature control unit.

The input terminals of the detection unit may be connected between the temperature control unit and the heater and to the power unit through a connection line formed in the dryer. Thus, the detection unit can detect power supply/cutoff through the connection line.

The dryer may include a display unit for displaying the clogging state of the air passage.

The dryer may also include an input unit for acquiring a user command for judging the clogging state of the air passage. Accordingly, the user can judge the clogging state of the air passage in a desired time.

Embodiments of the present invention may provide a dryer with a safety function that includes a temperature control unit turned on/off according to a temperature of an air passage, and a judgment unit for judging whether the temperature control unit can normally operate or not according to the on/off operation of the temperature control unit. Thus, the dryer may rapidly and precisely judge a breakdown of the temperature control unit, which is a thermostat.

The judgment unit may compute an accumulated time of the off operations of the temperature control unit, and may judge the temperature control unit to be unable to normally operate when the accumulated time is greater than a reference accumulated time. Therefore, the judgment unit can precisely judge the operation impossible state of the temperature control unit during a drying operation.

The dryer may include a display unit for displaying the judged result. Thus, the user can be informed of the normal operation possibility of the temperature control unit.

The dryer may also include an operation stopping unit interworking with the judgment unit for stopping a drying operation of the dryer.

The dryer may include a display unit interworking with the operation stopping unit for displaying the operation stop state of the operation unit.

The operation stopping unit may sequentially turn off a heater and a motor of the operation stopping unit. That is, the operation stopping unit preferentially turns off the heater to prevent an accident such as a fire by a breakdown of the temperature control unit during the drying operation, and then turns off the motor.

The dryer may include a storing unit for storing information on a judged result of a temperature control unit, and a display unit for displaying the information on the judged result after power application. When the user applies power to use the dryer, he/she may check the current operation possibility of the temperature controller.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A dryer with a clogging detecting function comprising:
a heater to heat air of an air passage;
a temperature control unit to turn a power supply to the heater on and off according to a temperature of the air passage or a temperature of the heater; and
a judgment unit to determine a clogging state of the air passage according to information received from the temperature control unit relating to the power supply being on or off.

2. The dryer of claim 1, further comprising a display unit to display information related to the clogging state of the air passage.

3. The dryer of claim 1, further comprising a comparison unit to compare information of the clogging state of the air passage with information of a prestored clogging state.

4. The dryer of claim 1, wherein the judgment unit determines a normal operation of the temperature control unit according to an on/off time of the temperature control unit.

5. The dryer of claim 4, further comprising an operation stopping unit to work with the judgment unit to stop a drying operation of the dryer.

6. A dryer with a clogging detecting function comprising:
a heater to heat air of an air passage;
a temperature control unit to turn on and to turn off a power supply to the heater according to a temperature of the air passage or a temperature of the heater;
a detection unit to detect an on/off state of the temperature control unit and to provide a detection signal based on the detected on/off state; and
a state judgment unit to determine a clogging state of the air passage by determining an off time of the temperature control unit according to the detection signal received from the detection unit.

7. The dryer of claim 6, wherein the state judgment unit comprises:
a comparison unit to compare the determined off time with a reference off time; and
a judgment unit to determine the air passage to be clogged when the determined off time is greater than the reference off time.

8. The dryer of claim 6, wherein the state judgment unit comprises:
an average computation unit to determine an average off time of a plurality of off times;
a comparison unit to compare the determined average off time with the reference off time; and
a judgment unit to determine the air passage to be clogged when the determined average off time is greater than the reference off time.

9. The dryer of claim 6, wherein a first input terminal of the detection unit is coupled between the temperature control unit and the heater and a second input terminal of the detection unit is coupled to a power unit to provide the power supply, and an output terminal of the detection unit is coupled to the state judgment unit.

10. The dryer of claim 9, wherein each of the first and second input terminals of the detection unit are separately coupled to a connection line.

11. The dryer of claim 6, further comprising a display unit to display information regarding the clogging state of the air passage.

12. The dryer of claim 6, further comprising an input unit to acquire a user command for judging the clogging state of the air passage.

13. A dryer with a safety function comprising:
a temperature control unit having on/off operations based on a temperature of an air passage; and
a judgment unit to determine whether the temperature control unit can operate normally or not based on the on/off operation of the temperature control unit.

14. The dryer of claim 13, wherein the judgment unit determines an accumulated time of the off operation of the temperature control unit, and the judgment unit determines that the temperature control unit is unable to normally operate when the accumulated time is greater than a reference accumulated time.

15. The dryer of claim 14, further comprising a display unit to display information regarding a judged result of the judgment unit.

16. The dryer of claim 13, further comprising an operation stopping unit to work with the judgment unit to stop a drying operation of the dryer.

17. The dryer of claim 16, further comprising a display unit to work with the operation stopping unit to display an operation stop state of the operation stopping unit.

18. The dryer of claim 16, wherein the operation stopping unit sequentially turns off a heater and a motor of the operation stopping unit.

19. The dryer of claim 14, further comprising:
a storing unit to store information on a judged result of the temperature control unit; and
a display unit to display the information on the judged result of the temperature control unit after power application.
